(19) United States
(12) Patent Application Publication
(10) Pub. No.: US 2016/0331172 A1
(43) Pub. Date: Nov. 17, 2016

(54) APPLIANCE FOR ATTACHING TREE TOPPERS AND METHODS OF USE

(71) Applicant: Renee S. Bauer, Michigan City, IN (US)

(72) Inventor: Renee S. Bauer, Michigan City, IN (US)

(21) Appl. No.: 14/713,658

(22) Filed: May 15, 2015

(51) Int. Cl. A47G 33/10; F16M 13/02

(52) U.S. Cl. CPC A47G 33/10; F16M 13/02

(57) ABSTRACT

Appliances capable of mounting toppers to the tops of trees, and methods for their use. Such an appliance includes a holder having an upper end, a lower end, a feature for supporting the holder on a lateral branch of the tree, and a feature for securing the holder to a main stem of the tree so that the holder is alongside and parallel to the main stem. The appliance further includes a support disposed at the upper end of the holder and adapted to receive a connector of a topper.

### BACKGROUND OF THE INVENTION

The present invention generally relates to appliances capable of mounting articles to trees and particularly to the tops of trees, for example, Christmas trees and other holiday trees.

The terms “topper” and “toppers” are used herein to refer to decorative ornaments of the types commonly or capable of being placed at the top of a live or artificial tree for decorative or ornamental purposes. Common examples include stars, angels, finials, etc. Conventionally, toppers used to decorate Christmas and other holiday evergreen trees have a conical-shaped or tubular-shaped connector adapted to be placed over and receive a leader at the top of the tree. However, leaders of evergreen trees are often not fully vertical, which results in the topper listing to one side, or may have a short leader that increases the risk that the topper will fall from the tree. An evergreen tree may also have multiple leaders that are laterally offset from the axis (nominal center) of the tree such that the use of one of the leaders to mount a topper results in the topper not being aligned with the tree axis.

Accordingly, there is a need for methods of improving the stability and positioning of toppers.

### BRIEF DESCRIPTION OF THE INVENTION

The present invention provides appliances capable of mounting toppers to the tops of trees, and methods for their use.

According to one aspect of the invention, an appliance adapted for mounting a topper to a top of a tree includes a holder comprising an upper end, a lower end, means for supporting the holder on a lateral branch of the tree, and means for securing the holder to a main stem of the tree so that the holder is alongside and parallel to the main stem. The appliance further includes a support disposed at the upper end of the holder and adapted to receive a connector of a topper.

Another aspect of the invention is a method of using the appliance comprising the elements described above. Such a method entails placing the holder in the top of a tree so that the supporting means is supported on a lateral branch of the tree, the securing means secures the holder to a main stem of the tree, the holder is alongside and parallel to the main stem, and the support protrudes from the top of the tree, and then placing a topper on the support so that the topper is above the top of the tree.

A preferred aspect of the invention is that the support replaces the leader of a tree for purposes of mounting a topper, and the appliance is configured such that the support is more stable and closer to true vertical than is likely an existing leader of the tree.

Other aspects and advantages of this invention will be further appreciated from the following detailed description.

### BRIEF DESCRIPTION OF THE DRAWINGS

FIG. 1 represents an appliance assembly in accordance with a first nonlimiting embodiment of this invention.

FIG. 2 depicts individual components of the appliance assembly of FIG. 1.

FIG. 3 represents an appliance assembly in accordance with a second nonlimiting embodiment of this invention.

FIG. 4 depicts individual components of the appliance assembly of FIG. 3.

FIG. 5 represents an appliance assembly in accordance with a third nonlimiting embodiment of this invention.

FIG. 6 depicts individual components of the appliance assembly of FIG. 5.

FIG. 7 represents the appliance assembly of FIG. 1 secured in an evergreen tree and mounting a topper thereto in accordance with a nonlimiting aspect of the invention.

### DETAILED DESCRIPTION OF THE INVENTION

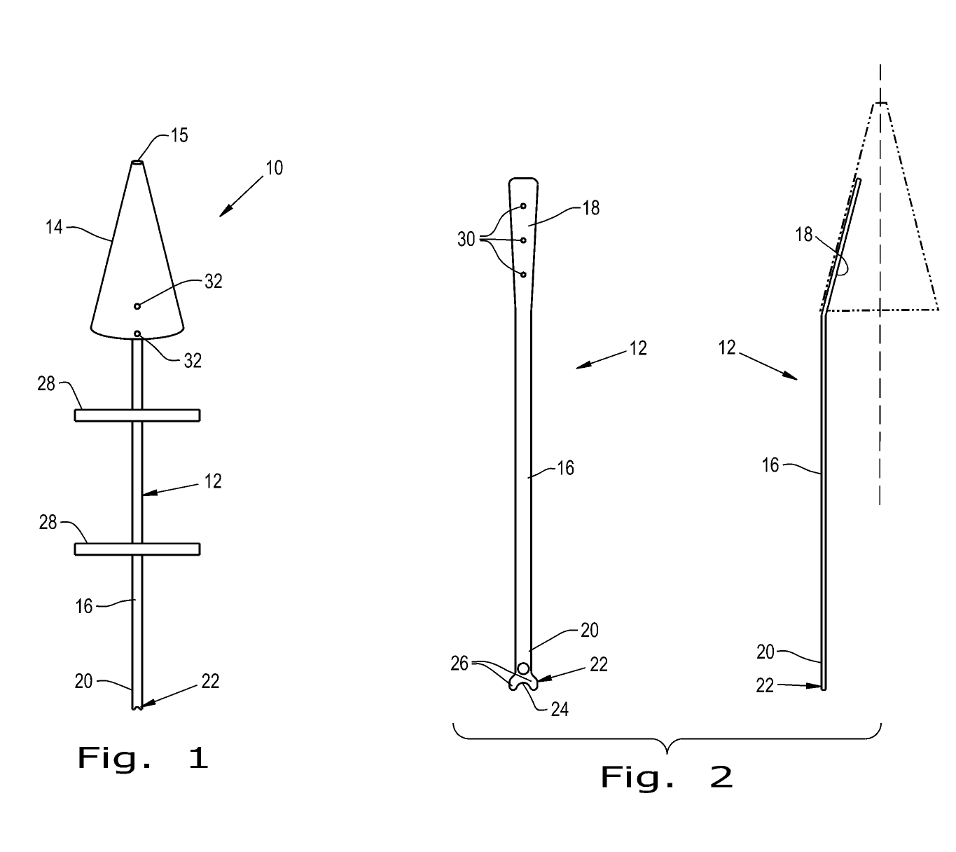

FIGS. 1 through 6 represent three embodiments of appliances for mounting toppers to trees, for example, a live or artificial Christmas tree or other holiday tree. Although the invention will be described hereinafter in reference to mounting toppers to trees, it will be appreciated that the teachings of the invention are more generally applicable to mounting toppers or similarly-constructed items to other structures. Each embodiment includes an elongate holder having Velcro straps or other means for securing the appliance to the main stem of the tree so that a portion of the holder protrudes from the top of the tree. Each embodiment also includes a support located at one end of the holder on which a topper can be placed and supported.

To facilitate the description of the embodiments of the appliances provided below, relative terms, including but not limited to, “vertical,” “horizontal,” “lateral,” “upper,” “lower,” “above,” “below,” “top,” etc., may be used in reference to the orientation of the appliances when installed in a tree, as represented in FIG. 7, and therefore are relative terms that indicate the construction, installation and use of the appliances and therefore help to define the scope of the invention. It should be further noted that the drawings are drawn for purposes of clarity when viewed in combination with the following description, and therefore are not necessarily to scale.

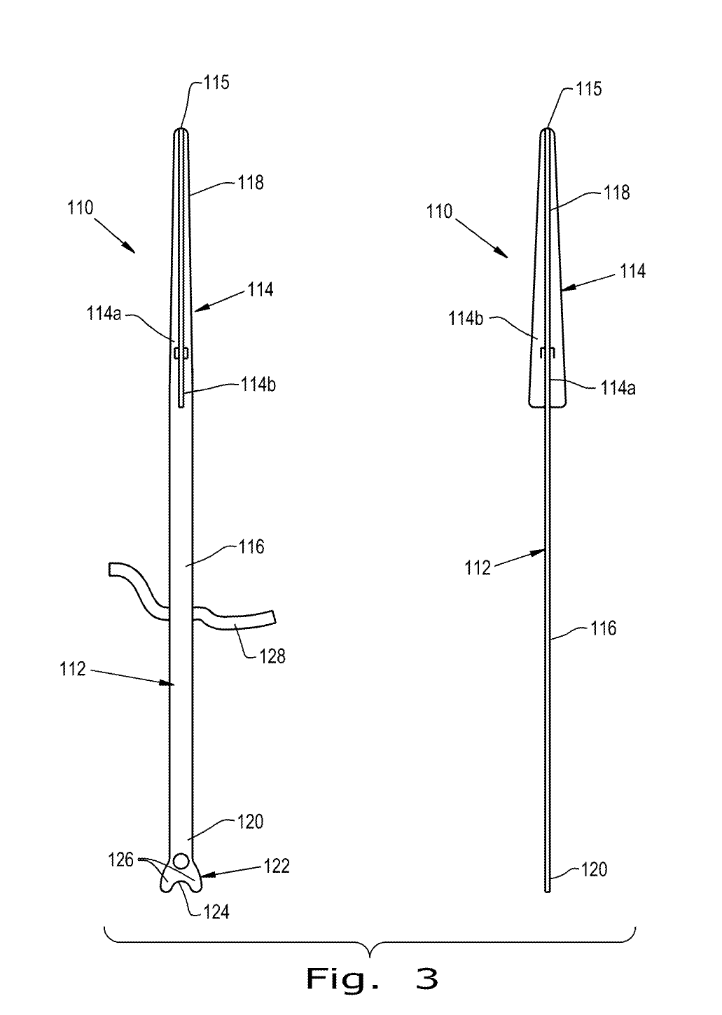

FIGS. 1 and 2 represent an appliance 10 comprising a holder 12 and a conical-shaped support 14 whose diameter uniformly increases in a direction away from its tip 15. The holder 12 comprises a main shank 16, a first (upper) end portion 18 at which the support 14 is disposed, and a second (lower) end portion 20 adapted to be placed in a tree. The shank 16 and the first and second end portions 18 and 20 of the holder 12 are depicted as linear portions, with the shank 16 and second end portion 20 being essentially collinear and the first end portion 18 being at an angle to the shank 16, for example, about fifteen degrees to the common axis of the shank 16 and second end portion 20. The holder 12, including its shank 16 and first and second end portions 18 and 20, can be originally formed of a single flat member with one end deformed to achieve the desired orientation of the first end portion 18. As will become apparent from the following discussion, the inclination of the first end portion 18 relative to the shank 16 will depend on the dimensions of the support 14.

The shank 16 and second end portion 20 of the holder 12 are adapted to be placed and secured within a tree so that the first end portion 18 is able to protrude from the top of the tree. For this reason, the shank 16 and second end portion 20 comprise features by which the holder 12 can be secured in a tree, and more particularly to a main stem of a tree. In the embodiment of FIGS. 1 and 2, the second end portion 20 is configured to have a fork 22 that defines an enlarged region at the lowermost extent of the second end portion 20 and is sized and adapted to engage a side branch of a tree as a result of placing the holder 12 in the tree so that the fork 22 rests on the top of the side branch, and so that, with the assistance of gravity, the side branch is retained or trapped within a recess 24 between legs 26 of the fork 22. A suitable radius for the recess 24 is roughly about one-quarter inch (about 6 mm), though it is foreseeable that greater or lesser radii may be appropriate, depending on the type and size of the tree in which the appliance 10 is to be used.

Also shown in the embodiment of FIGS. 1 and 2, straps 28 are provided on the shank 16 and adapted to wrap around the main stem of a tree to secure the shank 16 in an orientation that is essentially parallel and immediately alongside the main stem. Particularly preferred straps 28 include Velcro® straps, though it is foreseeable that a wide variety of means could be used that are capable of releasably securing the holder 12 to a main stem of a tree. The straps 28 may be secured at permanent locations along the length of the shank 16 or allowed to be freely moved along its length.

FIG. 2 shows multiple apertures 30 formed along the length of the first end portion 18. The apertures 30 enable the support 14 to be secured to the holder 12, for example, permanently secured with rivets 32 as shown in FIG. 1. The first end portion 18 is depicted as flaring outwardly toward the uppermost extent of the holder 12 to promote the stability of the support 14 when secured to the first end portion 18. The support 14 is depicted as a right circular cone in FIGS. 1 and 2, and the angular orientation of the first end portion 18 relative to the shank 16 is preferably selected so that, after mounting the support 14 to the first end portion 18, the axis of the cone defined by the support 14 is substantially parallel to the shank 16. As such, an appropriate angular orientation of the first end portion 18 relative to the shank 16 will depend on the slope of the lateral surface (side) of the support 14, which is directly attached to the first end portion 18, as well as the particular type of conical shape of the support 14 (e.g., right circular cone, oblique circular cone, etc.). It should be noted that the thickness of the holder 12 can be such that the angular orientation of the first end portion 18 relative to the shank 16 can be modified by the user.

The dimensions of the appliance 10 and its components can widely vary depending on the intended use of the appliance 10, the dimensions of the topper, and the size of the tree. The particular appliance 10 represented in FIGS. 1 and 2 is particularly well suited for mounting toppers and other ornamentations that have a relatively large conical-shaped connector. A suitable length for the appliance, from the fork 22 at the second end portion 20 to the tip 15 of the support 14, is about two feet or more and a suitable length for the support 14 is about eight inches or more if the appliance 10 is to be used with a tree of a size typical for residential housing. A suitable diameter at the base of the cone-shaped support 14 is about four inches. With such dimensions, the appliance can be placed in a tree so that its fork 22 rests on a lateral branch, its shank 16 can be secured with the straps 28, and the support 14 projects above the tree top so that a topper can be mounted to the support 14 as depicted in FIG. 7.

FIGS. 3 through 6 depict additional configurations of appliances in accordance with further embodiments of this invention. In these figures, consistent reference numbers are used to identify the same or functionally equivalent elements, but with a numerical prefix (1 or 2) added to distinguish the particular embodiment from the embodiment of FIGS. 1 and 2. In view of similarities between the embodiments, the following discussion of FIGS. 2 through 6 will focus primarily on aspects of the further embodiments that differ from the first embodiment in some notable or significant manner. Other aspects of the further embodiments not discussed in any detail can be, in terms of structure, function, materials, etc., essentially as was described for the first embodiment.

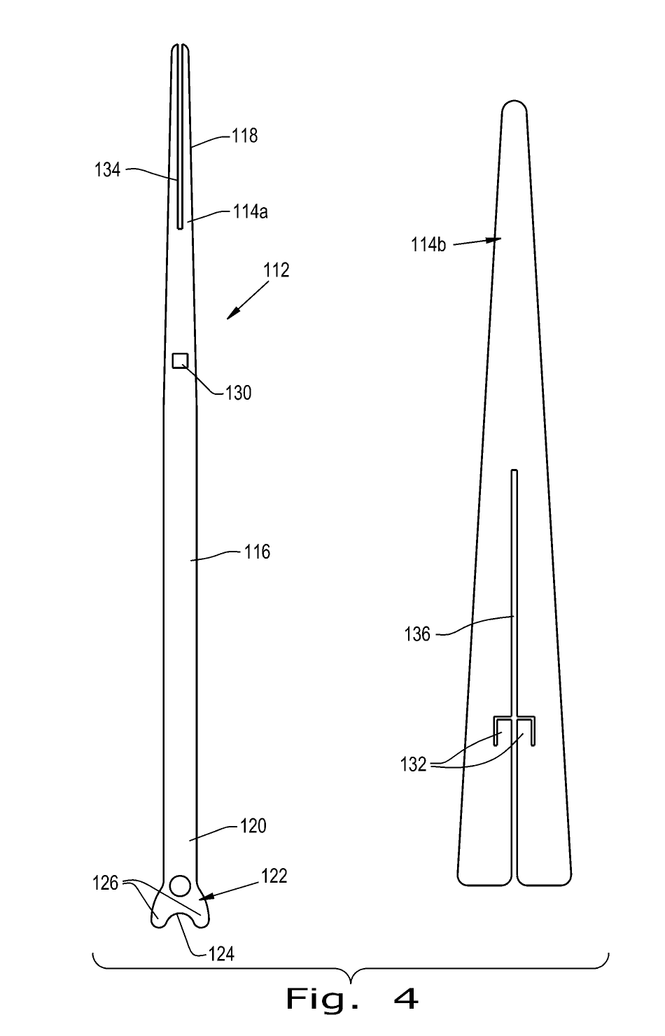

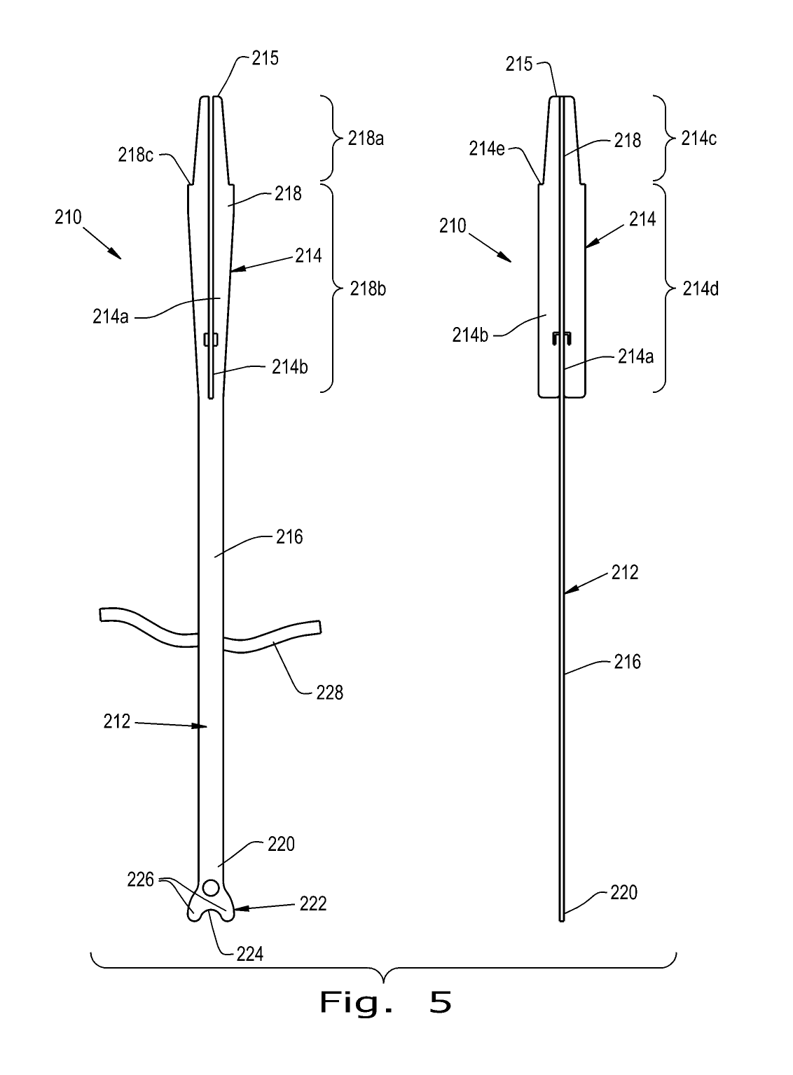

FIGS. 3 and 4 represent an appliance 110 comprising a holder 112 having a main shank 116, a first end portion 118 at which a support 114 is disposed, and a second end portion 120 adapted to be placed in a tree. The shank 116 and first and second end portions 118 and 120 are depicted as collinear and formed of a single flat member. As with the prior embodiment of FIGS. 1 and 2, the shank 116 can be equipped with one or more straps 128 by which the shank 116 can be secured to a main stem of a tree, and the second end portion 120 comprises a fork 122 that defines a recess 124 and legs 126 so that, with the assistance of gravity, a side branch of the tree can be retained or trapped within the recess 124 between the legs 126 to reliably support the holder 112.

The support 114 represented in FIGS. 3 and 4 has a tapered profile when viewed from the side and an X-shaped cross-section when viewed from above. The support 114 comprises a uniformly tapered triangular portion 114a defined at the first end portion 118 of the holder 112, and a triangular-shaped removable member 114b that has a uniform taper similar to that of the triangular portion 114a. In combination, the triangular portion 114a and removable member 114b result in the support 114 uniformly tapering with increasing width in a direction away from its tip 115 and toward the second end portion 120 of the holder 112. The removable member 114b is represented as being assembled to the first end portion 118 through complementary slots 134 and 136 formed in, respectively, the first end portion 118 and removable member 114b (FIG. 4). In addition, the removable member 114b is represented as being releasable secured to the first end portion 118 through tabs 132 that are formed in the removable member 114b on opposite sides of its slot 136 and can be bent or otherwise deformed to be received in an opening 130 in the shank 116 of the holder 112.

As with the previous embodiment, the dimensions of the appliance 110 and its components can widely vary. The particular appliance 110 represented in FIGS. 3 and 4 is particularly well suited for mounting finials and other ornamentations that have a relatively small conical-shaped connector, and therefore the lateral (width) dimensions of the triangular portion 114a and removable member 114b may be less than the diameter at the base of the cone-shaped support 14 of FIGS. 1 and 2. For example, a suitable width for the support 114 is about one inch. A suitable length for the support 214 is about seven inches, with the tapered region of the support 114 accounting for the entirety of its length.

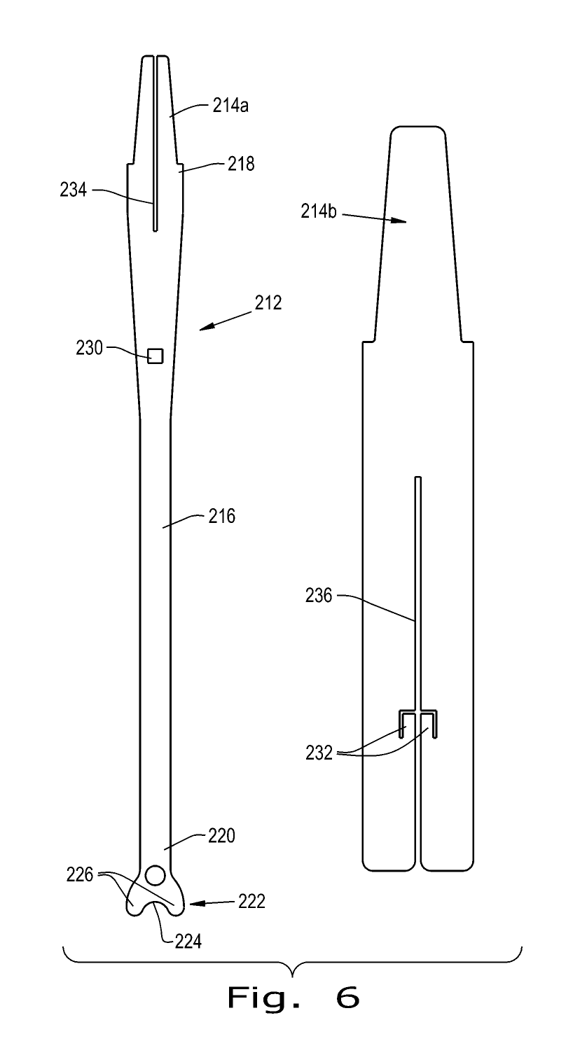

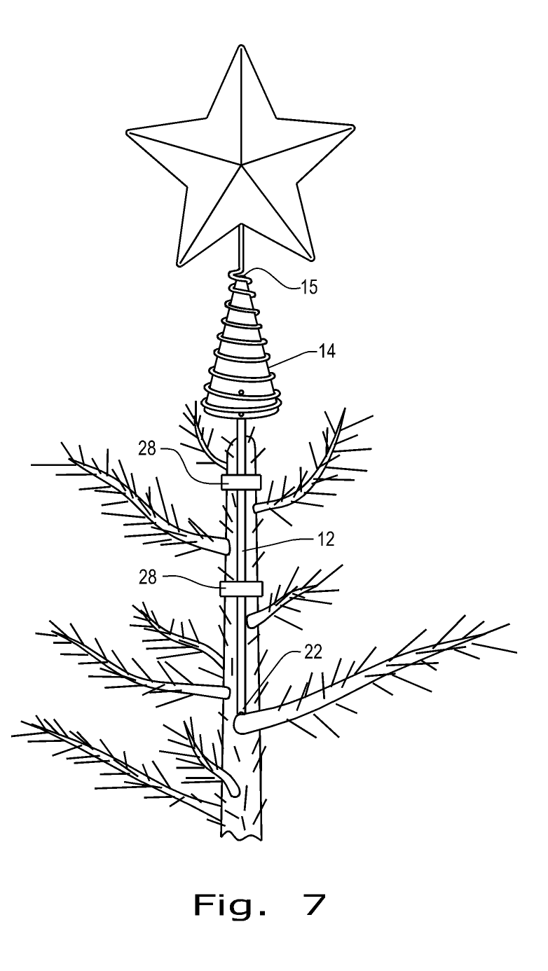

FIGS. 5 and 6 represent an appliance 210 that primarily differs from the embodiment of FIGS. 3 and 4 as a result of having a support 214 with a “stepped” profile when viewed from the side. As such, the appliance 210 comprises a holder 212 having a main shank 216, a first end portion 218 at which the support 214 is disposed, and a second end portion 220 adapted to be placed in a tree. As with the prior embodiments, the shank 216 can have one or more straps 228 by which the shank 216 can be secured to a main stem of a tree, and the second end portion 220 comprises a fork 222 that defines a recess 224 and legs 226 so that, with the assistance of gravity, a side branch of the tree can be retained or trapped within the recess 224 between the legs 226 to support the appliance 210. As with the embodiment of FIGS. 3 and 4, a removable member 214b is represented as being assembled to the first end portion 218 of the holder 112 through complementary slots 234 and 236 formed in, respectively, the first end portion 218 and removable member 214b, and the removable member 214b is releasable secured to the first end portion 218 through the cooperation of an opening 230 in the shank 216 and complementary tabs 132 in the removable member 214b.

The support 214 comprises a stepped portion 214a defined at the first end portion 218 of the holder 212, and a removable member 214b that also has stepped shape. The profile of the stepped portion 214a is a result of the first end portion 218 having a first region 218a that uniformly increases in width in a direction toward the second end portion 220 of the holder 212, a second region 218b that uniformly decreases in width in the direction toward the second end portion 220 of the holder 212, and an abrupt lateral step 218c therebetween. The profile of the removable member 214b has a first region 214c similar to the first region 218a of the stepped portion 214a, but a second region 214d of uniform width, and an abrupt lateral step 214e therebetween. In combination, the first regions 218a and 214c of the stepped portion 214a and removable member 214b result in the support 214 having a region immediately adjacent its tip 215 that uniformly tapers with increasing width in a direction toward the second end portion 220 of the holder 212.

As with the previous embodiments, the dimensions of the appliance 210 and its components can widely vary. The particular appliance 110 represented in FIGS. 5 and 6 is particularly well suited for toppers with tubular-shaped connectors, and therefore the lateral (width) dimensions of the support 214 and its stepped portion 214a and removable member 114b may be less than the diameter at the base of the cone-shaped support 14 of FIGS. 1 and 2. For example, a suitable width for the support 214 is about one inch. A suitable length for the support 214 is about seven inches, with the tapered region formed by the first regions 218a and 214c accounting for less than half of that length.

While the invention has been described in terms of specific or particular embodiments, it is apparent that other forms could be adopted by one skilled in the art. For example, the appliances 10, 110, and 210 and their components could differ in appearance and construction from the embodiments described herein and shown in the drawings, functions of certain components of the appliances 10, 110, and 210 could be performed by components of different construction but capable of a similar (though not necessarily equivalent) function, various materials could be used in the manufacturing of the appliances 10, 110, and 210 and their components. Accordingly, it should be understood that the invention is not limited to any embodiment described herein or illustrated in the drawings. It should also be understood that the phraseology and terminology employed above are for the purpose of describing the illustrated embodiments, and do not necessarily serve as limitations to the scope of the invention. Therefore, the scope of the invention is to be limited only by the following claims.

1. An appliance adapted for mounting a topper to a top of a tree, the appliance comprising:
a holder comprising an upper end portion, a lower end portion, a shank therebetween, means for supporting the holder on a lateral branch of the tree, and means for securing the holder to a main stem of the tree so that the holder is alongside and parallel to the main stem, wherein the shank and the lower end portion of the holder are collinear and the upper end portion is not collinear thereto, the upper end portion flaring outwardly to increase in a lateral width dimension in a direction toward an uppermost extent of the holder and away from the lower end portion of the holder; and
a support disposed at the upper end portion of the holder and adapted to receive a connector of a topper, the support having a tapered portion that increases in a lateral width dimension in a direction away from a tip of the support and toward the lower end portion of the holder, the tapered portion defining a lateral surface to which the upper end portion of the holder is attached, the upper end portion of the holder forming a predetermined angle relative to the shank such that an axis of the support is parallel to the shank and the lower end portion of the holder, wherein the lateral surface is not collinear with the axis of the support.

2. The appliance according to claim 1, wherein the holder is a single flat member with the upper end portion deformed to achieve the predetermined angle.

3. The appliance according to claim 1, wherein the support comprises a conical-shaped member.

4. The appliance according to claim 3, wherein the conical-shaped member is a right circular cone.

5. The appliance according to claim 1, wherein the upper end portion of the holder is located along and against the

6. The appliance according to claim 18, wherein the fork defines an enlarged region relative to the shank.

7. The appliance according to claim 1, wherein the support comprises a first tapered portion formed on the upper end portion of the holder and a second tapered portion formed on a member that is removably connected to the upper end portion of the holder, and the first and second tapered portions increases in a lateral width dimension in a direction away from a tip of the support and toward the lower end portion of the holder.

8. The appliance according to claim 7, wherein the support has an X-shaped cross-section.

9. The appliance according to claim 7, wherein the support, the first tapered portion, and the member are uniformly tapered along the entirety the support.

10. The appliance according to claim 7, wherein each of the first and second tapered portions are triangular shaped.

11. The appliance according to claim 1, wherein the support comprises a first tapered portion formed on the upper end portion of the holder and a second tapered portion formed on a member that is removably connected to the upper end portion of the holder, and the first and second tapered portions are disposed adjacent a tip of the support and increase in a lateral width dimension in a direction away from the tip and toward the lower end portion of the holder.

12. The appliance according to claim 11, wherein the support further comprises a third tapered portion formed on the upper end portion of the holder, the first and second tapered portions are between the third tapered portion and the tip of the support, and the third tapered portion decreases in a lateral width dimension in a direction away from the tip and toward the lower end portion of the holder.

13. The appliance according to claim 12, further comprising an abrupt lateral step between the first and third tapered portions on the upper end portion of the holder.

14. The appliance according to claim 12, wherein the support further comprises a fourth portion formed on the member, the second tapered portion is between the fourth portion and the tip of the support, and the fourth portion has a uniform lateral width dimension.

15. The appliance according to claim 14, further comprising an abrupt lateral step between the second tapered portion and the fourth portion on the member.

16. The appliance according to claim 1, wherein the securing means comprises straps disposed on the shank of the holder.

17. The appliance according to claim 1, wherein the supporting means comprises a fork that defines a lowermost extent of the lower end portion of the holder.

18. The appliance according to claim 17, wherein the fork comprises legs and a recess therebetween for engaging a lateral branch of a tree.

19. A method of using the appliance of claim 1, the method comprising:
placing the holder in the top of a tree so that the supporting means is supported on a lateral branch of the tree, the securing means secures the holder to a main stem of the tree, the holder is alongside and parallel to the main stem, and the support protrudes from the top of the tree; and
placing a topper on the support so that the topper is above the top of the tree.

20. The method according to claim 19, wherein the tree is a Christmas tree.
